(19) United States
(12) Patent Application Publication
(10) Pub. No.: US 2024/0197104 A1
(43) Pub. Date: Jun. 20, 2024

(54) FILTER FOR USE IN COMMERCIAL SIZE BREWING DEVICES AND MACHINES

(71) Applicant: Julie L. Hendrix Palmer, Orange Park, FL (US)

(72) Inventor: Julie L. Hendrix Palmer, Orange Park, FL (US)

(21) Appl. No.: 18/081,722

(22) Filed: Dec. 15, 2022

(51) Int. Cl. A47J 31/06

(52) U.S. Cl. CPC A47J 31/06

(57) ABSTRACT

The present invention is a filter for use in commercial size brewing devices and machines for preparing brewed foods and beverages, such as, but not limited to, cacao. The filter is sized and dimensioned for use in commercial size brewing devices and machines so as to allow for commercial size batches of brewed beverages to be produced. In a non-limiting embodiment, the filter includes a base portion, a sidewall, and an open top, and may also include a handle. The sidewall preferably includes alternating gold-mesh filter portions and portions of high-heat resistant plastic.

### BACKGROUND OF THE INVENTION

The present invention relates generally to filters for brewed foods and beverages. More specifically, the present invention is a filter for use in commercial size brewing devices and machines for preparing brewed foods and beverages, such as, but not limited to, cacao. The filter is sized and dimensioned for use in commercial size brewing devices and machines so as to allow for commercial size batches of brewed beverages to be produced.

An advantage of a gold coffee filter is flavor enhancement. Paper filters are designed to absorb much of the oil(s) surrounding the ground and roasted coffee beans. While some oil absorption may eliminate bitterness, paper filters often remove too much of the coffee's complex flavors contained in that oil. A gold coffee filter allows more oils to remain in the finished coffee, giving it a richer and more intense flavor. The mesh holds back unwanted coffee grounds like a paper filter, but some smaller grinds may be present in the finished product. The gold in the filter does not impart any metallic taste to the brew.

Yet another advantage of a gold filter is easy clean-up and maintenance. Paper coffee filters can be very messy to remove and discard, being filled with hot coffee grounds and oils. To empty a gold coffee filter, all one must do is pour out the contents and rinse thoroughly.

However, the gold filter may not be adequate for commercial size servings. Therefore, there is a need for a filter that is appropriate for commercial size cacao servings.

Still further, cacao needs to always brew on the slowest, boldest, and hottest setting on a coffee machine. Some coffee machines don't do some or all of that. For example, in the case of a filter and ground cacao, proper use requires pressing the “BOLD” button or the cacao brew will come out watery. Also, the usual coffee machine pot goes by six ounce servings and cacao measures for eight ounce servings requiring an extra step to carry out math, which can be onerous to many people. Still further, the max brewed cacao that can be made in a coffee machine is nine six ounce cups each time not twelve-fourteen like coffee, so it needs a larger filter in household machines also to accommodate more output.

There is need for a filter that will eliminate the above-discussed hassle.

It is an object of the present invention to provide a filter that is amenable for use in brewing cacao on a commercial scale.

Another object of the present invention is to provide a filter which is intended to be used in the making of beverages wherein contaminants are removed from the fluid before or after the fluid contacts the beverage making substances.

A further object of the present invention is to provide such a filter which is simple to manufacture and easy to use.

A yet further object of the present invention is to provide such a filter which is intended to be used in removing contaminants from fluids prior to or during the time such fluids are used for any purpose whatsoever, for example, for removing contaminants from a wide variety of fluids ranging from human drinking substances to commercial fluids such as gasoline or spent cooking or lubricating oils.

A still further object of this invention is to provide such a filter which could be used with conventional beverage making equipment without requiring any modification of such equipment.

The present invention overcomes one or more of the shortcomings of known filters for brewed foods and beverages. The Applicant is unaware of inventions or patent documents, taken either singly or in combination, which are seen to describe the present invention as claimed.

### SUMMARY OF THE INVENTION

The present invention is a filter for use in commercial size brewing devices and machines for preparing brewed foods and beverages, such as, but not limited to, cacao. The filter is sized and dimensioned for use in commercial size brewing devices and machines so as to allow for commercial size batches of brewed beverages to be produced. The filter comprises a base portion, a sidewall, and an open top, and may also comprise a handle.

In a non-limiting, preferred embodiment, the filter is in the shape of an inverted frustum of a right circular cone and has a planar first portion that is a base having a circular perimeter-defining element, a sidewall that extends between the base element and a rim, and an open top defined by the rim. The filter also has a handle, and includes alternating gold-mesh filter portions and portions of high-heat resistant plastic.

### BRIEF DESCRIPTION OF THE DRAWINGS

FIG. 1 is a perspective, top view of an embodiment of a filter for use in commercial size brewing devices and machines according to the present invention;

FIG. 2 is a perspective, bottom view of the filter of FIG. 1; and

FIG. 3 is a top plan view of the filter of FIG. 1.

It should be understood that the above-attached figures are not intended to limit the scope of the present invention in any way.

### DETAILED DESCRIPTION OF THE EMBODIMENTS OF THE PRESENT INVENTION

Other objects, features and advantages of the invention will become apparent from a consideration of the following detailed description and the accompanying drawings.

The present invention is a filter 10 for use in commercial size brewing devices and machines for preparing brewed foods and beverages, such as, but not limited to, cacao (specifically ground cacao). This filter 10 will work for coffee (specifically ground coffee) and the like also. The filter 10 is sized and dimensioned for use in commercial size brewing devices and machines so as to allow for commercial size batches of brewed beverages to be produced. The filter 10 comprises a base portion 20, a sidewall 30, and an open top 100, and may also comprise a handle 50.

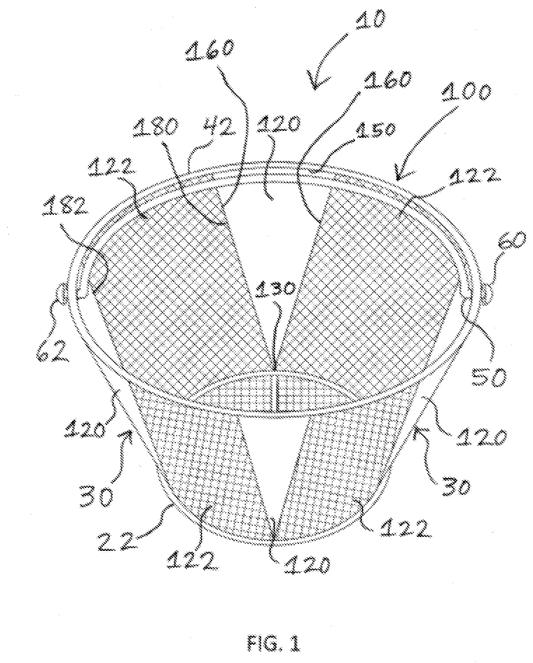

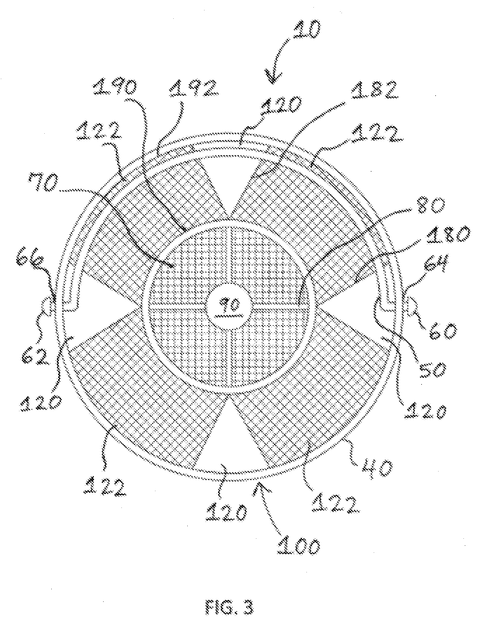

In a non-limiting, preferred embodiment and as shown in FIGS. 1-3, the filter 10 is in the shape of an inverted frustum of a right circular cone and has a planar first portion 20 that is a base having a circular perimeter-defining element 22, a sidewall 30 that extends between the base element 22 and a rim 40, and an open top 100 defined by the rim 40. A circular support element 42 defines rim 40. Sidewall 30 angles outwardly between base element 22 and rim 40 to define the cone shape of the filter 10. The planar base portion 20 allows filter 10 to be used with commercial size servings of ground cacao.

A handle 50 is rotationally attached to the rim 40 of the filter 10 by posts 60 and 62 on the ends of the handle 50 and which are accommodated in associated mounts 64 and 66 on the filter 10 adjacent to the rim 40. Handle 50 is used to move the filter 10 as necessary.

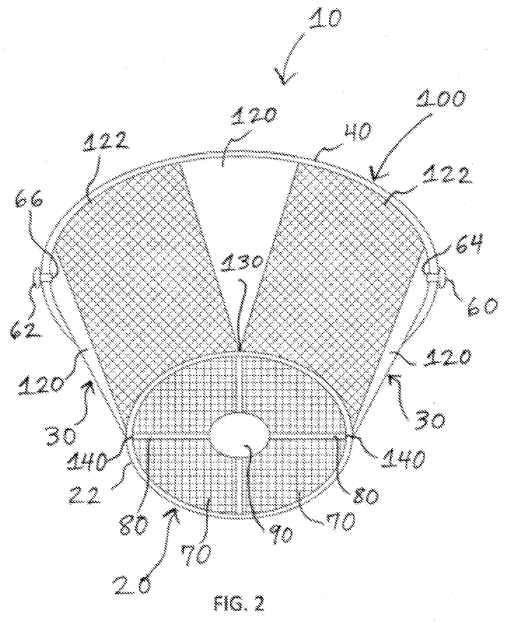

As can be understood from FIGS. 1 and 2, the filter base 20 includes a plurality of foraminous screen portions, such as portion 70, separated by support arms, such as support arm 80, radiating outwardly from a center section 90 to circular perimeter-defining element 22.

The sidewall 30 is divided into a plurality of triangular sections, such as sections 120 and polygonal sections 122. Sections 120 have an apex 130 located adjacent to an outer end 140 of each radial support arm 80 in the base of the filter 10 and a base 150 located on the rim 40 of the filter 10. Sides 160 of each section 120 extend between the apex and the base of each triangular section and are angled away from each other as viewed from the base to the apex. Sections 120 are formed of high heat-resistant plastic.

Sections 122 are interposed between sections 120 and extend from circular perimeter-defining element 22 to rim support element 42. Sections 122 are formed of gold tone metal mesh in the nature of a gold coffee filter. Sections 122 are arcuate-ended trapeziums having linear sides 180 and 182 that are angled away from each other as measured from base 20 to rim 40, and arcuate ends 190 and 192 located respectively on circular perimeter-defining element 22 and on rim 40.

As a non-limiting example of the filter 10 of the present invention, the base 20 has a diameter of about four and a half inches, the sidewall 30 has a height of about three and a half inches, and the open top 100 has a diameter of about six inches.

It is to be understood that the present invention is not limited to the embodiments described above or as shown in the attached figures, but encompasses any and all embodiments within the spirit of the invention. It is understood that while certain forms of the present invention have been illustrated and described herein, it is not to be limited to the specific forms or arrangements of parts described and shown.

1. A filter for use in commercial size brewing devices and machines, said filter comprising:
a planar base having a circular perimeter and a plurality of foraminous screen sections; and
a sidewall in the shape of a frustum of a right circular cone,
wherein said sidewall comprises an apex portion connected to said perimeter of said base, a base portion spaced apart from said apex portion, plurality of foraminous metal mesh sections, and a plurality of liquid-impervious sections,
wherein said sidewall angles outwardly with respect to said base portion between said base portion and said apex portion,
wherein said plurality of foraminous metal mesh sections which are spaced apart from each other about said sidewall,
wherein each of said plurality of liquid-impervious sections being interposed between adjacent foraminous metal mesh sections of said sidewall, and
wherein said filter is dimensioned and configured for use in commercial size brewing devices and machines so as to allow for commercial size batches of brewed beverages to be produced.

2. The filter according to claim 1, wherein said plurality of foraminous metal mesh sections of said sidewall are made or manufactured of a gold material.

3. The filter according to claim 2, wherein said plurality of liquid-impervious sections of said sidewall are made or manufactured of a high heat-resistant plastic material.

4. The filter according to claim 3, wherein said plurality of foraminous metal mesh sections of said sidewall are trapeziums in shape.

5. The filter according to claim 4, wherein said sidewall has a rim which is spaced apart from said planar base, wherein said plurality of liquid-impervious sections are triangular in shape, and wherein each of said plurality of liquid-impervious sections has an apex located adjacent to said planar base and a base located adjacent to said rim of said sidewall.

6. The filter according to claim 5, further including a circular perimeter-defining element circumferentially surrounding said planar base and is interposed between said apexes of said plurality of liquid-impervious sections of said sidewall and said planar base and between said plurality of foraminous metal mesh sections of said sidewall and said planar base.

7. The filter according to claim 6, further including a plurality of support arms and a handle, wherein each of said plurality of support arms is interposed between adjacent foraminous portions of said planar base, and wherein said handle is pivotably connected to said rim of said sidewall.

8. (canceled)

9. The filter according to claim 1, wherein said base has a diameter of about four and a half inches, and wherein said sidewall has a height of about three and a half inches.

10. The filter according to claim 1, wherein filter is suitable for brewing cacao.

11. A filter for use in commercial size brewing devices and machines, said filter comprising:
a base having a perimeter and a plurality of foraminous screen sections;
a sidewall comprising an apex portion connected to said perimeter of said base, a base portion spaced apart from said apex portion, plurality of foraminous metal mesh sections, and a plurality of liquid-impervious sections,
wherein said sidewall angles outwardly with respect to said base portion between said base portion and said apex portion,
wherein said plurality of foraminous metal mesh sections which are spaced apart from each other about said sidewall, and
wherein each of said plurality of liquid-impervious sections being interposed between adjacent foraminous metal mesh sections of said sidewall; and
an open top,
wherein said filter is dimensioned and configured for use in commercial size brewing devices and machines so as to allow for commercial size batches of brewed beverages to be produced.

12. The filter according to claim 11, wherein said base is a planar base having a circular perimeter, and wherein said sidewall is in the shape of a frustum of a right circular cone.

13. The filter according to claim 11, wherein said plurality of foraminous metal mesh sections of said sidewall are made or manufactured of a gold material.

14. The filter according to claim 11, wherein said plurality of liquid-impervious sections of said sidewall are made or manufactured of a high heat-resistant plastic material.

15. The filter according to claim 11, wherein said plurality of foraminous metal mesh sections of said sidewall are trapeziums in shape.

16. The filter according to claim 11, further in wherein said base has a diameter of about four and a half inches, wherein said sidewall has a height of about three and a half inches, and wherein said open top has a diameter of about six inches, and wherein said handle is pivotably connected to said rim of said sidewall.

17. (canceled)

18. The filter according to claim 11, further including a handle pivotably connected to a rim of said sidewall.

19. The filter according to claim 11, wherein filter is suitable for brewing cacao, wherein said base is a planar base having a circular perimeter, wherein said sidewall is in the shape of a frustum of a right circular cone, wherein said plurality of foraminous metal mesh sections of said sidewall are made or manufactured of a gold material, and said plurality of liquid-impervious sections of said sidewall are made or manufactured of a high heat-resistant plastic material.

20. The filter according to claim 11, wherein said base has a diameter of about four and a half inches, wherein said sidewall has a height of about three and a half inches, and wherein said open top has a diameter of about six inches.

21. A filter for use in commercial size brewing devices and machines, said filter comprising:
a filter body which is in the shape of a frustum of a right circular cone,
wherein said filter body comprises:
a circular planar base, and
a conical sidewall which extends outwardly from said planar base at an oblique angle with respect to said planar base,
wherein said planar base has a plurality of foraminous mesh sections,
wherein said sidewall has a plurality of foraminous mesh sections and a plurality of heat-resistant liquid-impervious portions,
wherein each of said plurality of liquid-impervious sections of said sidewall is interposed between adjacent foraminous mesh sections of said sidewall, and
wherein said filter is dimensioned and configured for use in commercial size brewing devices and machines so as to allow for commercial size batches of brewed beverages to be produced.

22. The filter according to claim 21, wherein said base has a diameter of about four and a half inches, and wherein said sidewall has a height of about three and a half inches.
